(19) United States
(12) Patent Application Publication
(10) Pub. No.: US 2009/0276064 A1
(43) Pub. Date: Nov. 5, 2009

(54) PORTABLE AUDIO PLAYBACK DEVICE AND METHOD FOR OPERATION THEREOF

(75) Inventor: Jozef Pieter Van Gassel, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/722,106

(22) PCT Filed: Dec. 20, 2005
(86) PCT No.: PCT/IB2005/054335

§ 371 Date: Jun. 19, 2007

(30) Foreign Application Priority Data
Dec. 22, 2004 (EP) 04106843.8

(51) Int. Cl. G06F 17/00

(52) U.S. Cl. 700/94

(57) ABSTRACT

The present invention relates to a portable audio playback device (100) which comprise means for storage (101) of at least one spoken word audio book, and means for storage (101) of at least one music audio items. The device further comprise associated user interlace means (108) for enabling user selection of a spoken word audio book and user selective assembly of a music play list including at least one of said music audio items, and means for simultaneous playback (110) of said user selected spoken word audio book and said at least one music audio item of said user assembled music play list.

### BACKGROUND OF THE INVENTION

1. Field of the Invention

The present invention relates to a portable audio playback device.

The present invention also relates to a method for enabling simultaneous playback of audio items on a portable audio playback device.

2. Prior Art

Currently a new category of portable audio playback device consumer electronic products is emerging in the consumer market space. Some examples in this category are the Apple iPod and the HDD100 and HDD60 products from Philips.

Audio playback devices like the Apple iPod support content, e.g. such as provided by the website “audible.com”, for playing back so called audio books, i.e. spoken word books. Especially in the United States audio books are becoming increasingly popular. These types of books are often “consumed” while traveling; commuting by car, train and subway or on airports and planes.

With traditional paper books, readers often listen to music in the background while reading the printed book. With audio books, especially on a mobile device, the user has to choose between the two since he or she may only wear one set of headphones at a time. This means that he or she may either listen to the spoken word book or the music but not both at the same time. An audio book played back on such a known mobile player makes it impossible to listen to music while “reading” the book at the same time, although a lot of music content might be available on the same mobile device.

Usually the audio book is a recording of a narrator reading the actual book, without any acting or music in the background. In some productions there is also music in the background, but for magazines and other periodicals this would be expensive and it would not be obvious what music to choose as this depend largely on user preferences. Also adding music to the audio book would increase the bit-rate significantly since the low bit-rate speech coding algorithms cannot be used for playing back music.

CN 1412687 A relates to an electronic book device which includes an electronic book data base, a speech data base, a background music data base, an input nodule, a control module, an analysis module and a playback module. The input module may be used for giving a command for starting background music or for giving a command for reading. The control module is used for controlling the electronic book device, and the analysis module may be used for analyzing electronic book contents and picking up a speech data address word-by-word from the speech data base. The playback module is used for playing back background music or speech data. The speech data base further includes an actual person pronunciation step and a Text To Speech (TTS) step, so that the user may select an actual person pronunciation or a synthetic pronunciation mode. The electronic book device is arranged to either provide an electronic book as a text to be read by a user thereof from a display of the device, or alternatively using the Text To Speech functionality provide an audible reading of the electronic book. If the user selects to read the book from the display of the device, i.e. without any audible playback of the electronic book, the user will have the opportunity to select and playback background music from the background music data base. However, this background music option is not available should the user select to have an audible reading of the electronic book by the device.

In view of the prior art, there is a need for a portable audio playback device, which resolves these and other types of conflicts.

### SUMMARY OF THE INVENTION

Therefore it is an object of the present invention to provide a portable audio playback device, which resolves the conflicts of the prior art portable audio playback devices.

It is a further object of the present invention to provide a portable audio playback device allowing for simultaneous playback of a spoken word audio book and background music.

Accordingly, a portable audio playback device is provided. The portable audio playback device comprises; means for storage of at least one spoken word audio book; means for storage of at least one music audio item; user interface means for enabling user selection of a spoken word audio book and user selective assembly of a music play list including at least one of said music audio items; and means for simultaneous playback of said user selected spoken word audio book and said at least one music audio item of said user assembled music play list.

In the portable audio playback device said means for storage of at least one spoken word audio book and said means for storage of at least one music audio items preferably comprise a hard disk drive.

In a preferred embodiment of the portable audio playback device of the present invention, the means for storage of said at least one spoken word audio book and said plurality of music audio items are arranged to store these as digital audio-data.

In yet a more preferred embodiment of the portable audio playback device of the present invention, the portable audio playback device further comprises audio-data processing means, and means for converting digital audio-data to an analogue audio signal.

Preferably, the portable audio playback device further comprises means for synchronizing playback of said at least one spoken word audio book with playback of said at least one music audio item of said user assembled music play list. In an enhancement of the previous embodiment said means for synchronization are arranged to perform said synchronization on the basis of chapter boundaries of said at least one spoken word audio book.

In yet another embodiment of the portable audio playback device said means for user selective assembly of said music play list further comprises means for user selective automated assembly of said music play list. In an enhancement of the previous embodiment said means for user selective automated assembly of said music play list further comprise means for basing the automatically provided content of said associated music play list on words found in the text of the spoken word audio book, or alternatively said means for user selective automated assembly of said music play list further comprise means for extracting markers having been pre-inserted into the spoken word audio book, and means for combining information embedded in said markers with user indicated preferences for generation of said music play list.

In yet a further embodiment of the portable audio playback, said device further comprises an associated set of earphones, wherein a biosensor is embedded in said earphones, and said portable audio storage and playback device further comprise means for acquiring Electro Encephalogram information from a user by means of said biosensor, and means for using said acquired Electro Encephalogram information for monitoring the concentration of said user and stop the playback, or alternatively insert a marker for facilitating a jump back to a particular point in the spoken word audio book at a later stage, in case the acquired Electro Encephalogram information indicates that the concentration of said user has decreased.

In a still further embodiment of the portable audio playback, said associated user interface means at least partially is provided on a separate device and arranged such that said user selection of a spoken word audio book and user selective assembly of a music play list may be performed on said separate device and transferred to said portable audio playback device.

In yet a further embodiment of the portable audio playback, said device further comprises a biosensor and said portable audio storage and playback device further comprise means for acquiring Electro Encephalogram information from a user by means of said biosensor, and means for using said acquired Electro Encephalogram information for monitoring the concentration of said user and stop the playback, or alternatively insert a marker for facilitating a jump back to a particular point in the spoken word audio book at a later stage, in case the acquired Electro Encephalogram information indicates that the concentration of said user has decreased.

Also provided is a method for enabling simultaneous playback of audio on a portable audio playback device. The method comprising the steps of: storing of at least one spoken word audio book in a memory of said portable audio playback device; storing of at least one music audio items in said memory of said portable audio playback device; providing to a display of said portable audio playback device a graphical user interface for enabling user selection of a spoken word audio book and user selective assembly of a music play list including at least one of said music audio items; and simultaneous playback of said user selected spoken word audio book and said at least one music audio item of said user assembled music play list.

The present invention also relates to a computer program, which is stored on a computer readable storage media, and which is suitable to perform the above method when it is run on a digital computer.

The present invention further also relates to a computer program product, which is directly loadable into the internal memory of a digital computer, and which comprises a computer program for performing the above method when said program is run on said computer.

### BRIEF DESCRIPTION OF THE DRAWINGS

These and other features, aspects, and advantages of the apparatus and method of the present invention will become better understood with regard to the following description, appended claims, and accompanying drawing where:

FIG. 1 illustrates schematically the configuration of the portable audio playback device of the present invention.

### DETAILED DESCRIPTION OF THE PREFERRED EMBODIMENT

Although this invention is applicable to numerous and various types of portable audio playback devices, it has been found particularly useful in the environment of hard disk drive based portable audio playback devices. Therefore, without limiting the applicability of the invention to hard disk drive based portable audio playback devices, the invention will be described in such an environment.

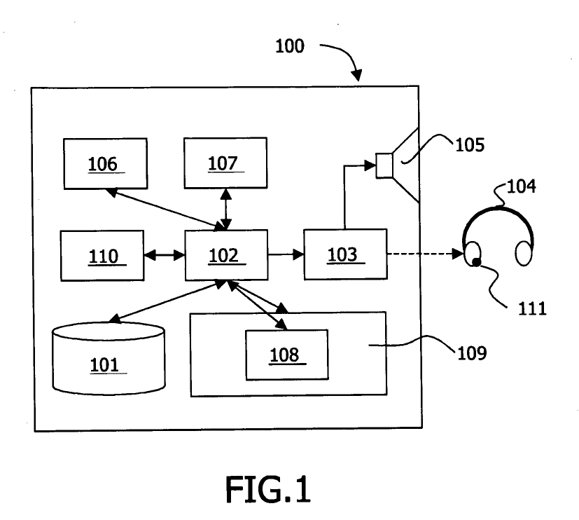

Referring now to FIG. 1, there is illustrated schematically a hard disk drive based portable audio playback device of the present invention, generally referred to by reference numeral 100. The hard disk drive based portable audio playback device 100 includes memory means 101, in this embodiment a hard disk drive as mentioned above. The memory means 101 is adapted for storage and playback of audio-data, which audio-data in a preferred embodiment will be stored as digital audio-data.

The hard disk drive based portable audio playback device 100 also includes audio-data processing means 102, and means (not shown) for converting digital audio-data to an analogue audio signal. An amplifier system 103 amplifies the analogue audio signal for output to e.g. a headset 104 or a loud-speaker 105 of the device. It is preferred that the audio-data processing means 102 is a computer or any other processor having an associated storage device such as the hard disk drive 101. However, those skilled in the art will recognize that the audio storage and playback system may be of any type known in the art without departing from the scope and spirit of the present invention.

The portable audio storage and playback device 100 of the present invention supports playback of spoken word audio books. However, the portable audio storage and playback device 100 of the present invention also supports playback of music audio items and is arranged to accommodate on its hard disk drive 101 a large collection of audio, both spoken word audio books and music audio items. Decoders 106, 107 for both spoken word audio book and music audio items are present in the portable audio storage and playback device 100 of the present invention.

A user interface 108 is provided to the portable audio storage and playback device 100 of the present invention. The user interface 108 is preferably arranged to be presented to display means 109 of the portable audio storage and playback device 100 and user interaction therewith facilitated either through said display means 109 being touch sensitive or alternatively through hardware buttons or similar (not shown) associated with said display means 109. This user interface 108 is arranged for allowing a user to selectively assemble a music play list and associating the assembled music play list with a spoken word audio book. Alternatively, the associated user interface means may at least partially be provided on a separate device, such as on a personal computer, and arranged such that said user selection of a spoken word audio book and user selective assembly of a music play list may be performed on said separate device and transferred to said portable audio playback device 100. The portable audio storage and playback device 100 of the present invention further comprise means 110 for simultaneous playback of a spoken word audio book and the music audio items of the associated play list.

Hence, in accordance with the present invention there is provided the functionality and matching user interface 108 that allows a user to mix music available on the portable audio storage and playback device 100 in the background of the spoken word recitation of an audio book. The spoken word audio book may be stored using speech coding or as text, using text to speech synthesis on playback, while the music is stored using audio coding. In accordance with the present invention a user will be able to select for playback the songs, albums and play lists of his/hers preference.

As will be evident for the person skilled in the art, in case of the memory means 101 being a hard disk drive, special buffering techniques may be used as the means to synchronize the music audio items with the spoken word audio and to make sure that the power consumption of the portable audio storage and playback device 100 is minimal.

In order to assist a user in creating a play list that fits to the content of a particular audio book, special enhancements may be made. For instance, the audio book could be authored in such a way that music may be easily synchronized in time. The synchronization may take place on the basis of chapter boundaries and the actual content of an associated music play list may be based on words found in the text of the audio book.

In a further embodiment there is envisaged audio book authored in such a way that this process may be automated, e.g. by explicitly adding musical mood recommendations. Special markers are inserted in the spoken word data which the playback device may extract for this purpose. The portable audio storage and playback device 100 may combine this embedded information with the preferences of the user and automatically generate an appropriate play list.

In yet a further embodiment of the present invention, it is envisaged that a special biosensor 111 is embedded in the earphones 104 of the portable audio storage and playback device 100 and that the portable audio storage and playback device 100 could be used to acquire Electro Encephalogram (EEG) information in order to monitor the listeners physical state. One of the disadvantages of an audio book is that the reading does not stop when the user gets tired. The acquired EEG information may be used to monitor the concentration of the user, i.e. mental state, and stop the playback, or alternatively insert a marker to jump back to a particular point in the audio book at a later stage in case the concentration of the user decreases, e.g. as the user gets tired or falls asleep.

In a still further embodiment of the present invention, it is envisaged that the portable audio storage and playback device further comprises an associated biosensor 111 and means for acquiring Electro Encephalogram (EEG) information from a user by means of the biosensor 111. This information may be used as describes with the previous embodiment.

The present invention also relates to a method for enabling simultaneous playback of audio on a portable audio playback device. The method in accordance with the present invention comprises the steps of: storing of at least one spoken word audio book in a memory of the portable audio playback device; storing of at least one music audio items in the memory of the portable audio playback device; providing to a display of the portable audio playback device a graphical user interface for enabling user selection of a spoken word audio book and user selective assembly of a music play list including at least one of the music audio items; and simultaneous playback of the user selected spoken word audio book and the at least one music audio item of the user assembled music play list.

In a preferred embodiment of the present invention the above method is implemented in software suitable for controlling the functionalities of the portable audio storage and playback device 100. This may be realized as a computer program, which is stored on a computer readable storage media, and which is suitable to perform the above method when it is run on a digital computer, such as is obvious for the person skilled in the art is a common component for controlling the functionalities of a portable audio storage and playback device such as the portable audio storage and playback device 100 in accordance with the present invention. Alternatively this may be realized as a computer program product, which is directly loadable into the internal memory of a digital computer, and which comprises a computer program for performing the above method when said program is run on said computer, once again such as is obvious for the person skilled in the art is a common component for controlling the functionalities of a portable audio storage and playback device such as the portable audio storage and playback device 100 in accordance with the present invention.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

1. A portable audio playback device (100) comprising:
means for storage (101) of at least one spoken word audio book;
means for storage (101) of at least one music audio item;
associated user interface means (108) for enabling user selection of a spoken word audio book and user selective assembly of a music play list including at least one of said music audio items; and
means for simultaneous playback (110) of said user selected spoken word audio book and said at least one music audio item of said user assembled music play list.

2. The portable audio playback device (100) of claim 1, wherein said means for storage of at least one spoken word audio book and said means for storage of at least one music audio items comprise a hard disk drive.

3. The portable audio playback device (100) of claim 2, wherein said means for storage (101) of said at least one spoken word audio book and said plurality of music audio items are arranged to store these as digital audio-data.

4. The portable audio playback device (100) of claim 3, further comprising audio-data processing means (102), and means converting digital audio-data to an analogue audio signal.

5. The portable audio playback device (100) of claim 1, further comprising means for synchronizing playback of said at least one spoken word audio book with playback of said at least one music audio item of said user assembled music play list.

6. The portable audio playback device (100) of claim 5, wherein said means for synchronization are arranged to perform said synchronization on the basis of chapter boundaries of said at least one spoken word audio book.

7. The portable audio playback device (100) of claim 1, wherein said means for user selective assembly of said music play list further comprises means for user selective automated assembly of said music play list.

8. The portable audio playback device (100) of claim 7, wherein said means for user selective automated assembly of said music play list further comprises means for basing the automatically provided content of said associated music play list on words found in the text of the spoken word audio book.

9. The portable audio playback device (100) of claim 7, wherein said means for user selective automated assembly of said music play list further comprise means for extracting markers having been pre-inserted into the spoken word audio book, and means for combining information embedded in said markers with user indicated preferences for generation of said music play list.

10. The portable audio playback device (100) of claim 1, further comprising an associated set of earphones (104), wherein a biosensor (111) is embedded in said earphones (104), and said portable audio storage and playback device (100) further comprise means for acquiring Electro Encephalogram information from a user by means of said biosensor (111), and means for using said acquired Electro Encephalogram information for monitoring the concentration of said user and stop the playback, or alternatively insert a marker for facilitating a jump back to a particular point in the spoken word audio book at a later stage, in case the acquired Electro Encephalogram information indicates that the concentration of said user has decreased.

11. The portable audio playback device (100) of claim 1, further comprising an associated biosensor (111) and said portable audio storage and playback device (100) further comprise means for acquiring Electro Encephalogram information from a user by means of said biosensor (111), and means for using said acquired Electro Encephalogram information for monitoring the concentration of said user and stop the playback, or alternatively insert a marker for facilitating a jump back to a particular point in the spoken word audio book at a later stage, in case the acquired Electro Encephalogram information indicates that the concentration of said user has decreased.

12. The portable audio playback device (100) of claim 1, wherein said associated user interface means (108) at least partially are provided on a separate device and arranged such that said user selection of a spoken word audio book and user selective assembly of a music play list may be performed on said separate device and transferred to said portable audio playback device (100).

13. A method for enabling simultaneous playback of audio items on a portable audio playback device (100) comprising the steps of:
storing of at least one spoken word audio book in a memory of said portable audio playback device (100);
storing of at least one music audio items in said memory of said portable audio playback device (100);
providing to a display (109) of said portable audio playback device (100) a graphical user interface (108) for enabling user selection of a spoken word audio book and user selective assembly of a music play list including at least one of said music audio items; and
simultaneous playback of said user selected spoken word audio book and said at least one music audio item of said user assembled music play list.

14. A computer program, which is stored on a computer readable storage media, and which is suitable to perform the method of claim 13 when it is run on a digital computer.

15. A computer program product, which is directly loadable into the internal memory of a digital computer, and which comprises a computer program for performing the method of claim 13 when said program is run on said computer.
